(19) United States
(12) Patent Application Publication
(10) Pub. No.: US 2021/0125018 A1
(43) Pub. Date: Apr. 29, 2021

(54) SYSTEMS AND METHODS FOR ENCODING SECURITY TAGS WITH DYNAMIC DISPLAY FEATURE

(71) Applicant: Adam S. Bergman, Boca Raton, FL (US)

(72) Inventor: Adam S. Bergman, Boca Raton, FL (US)

(73) Assignee: SENSORMATIC ELECTRONICS, LLC, Boca Raton, FL (US)

(21) Appl. No.: 16/605,420

(22) PCT Filed: Apr. 19, 2017
(86) PCT No.: PCT/US2017/028373

§ 371 Date: Oct. 15, 2019

(51) Int. Cl. G06K 19/077; G06K 19/07

(52) U.S. Cl. CPC G06K 19/07707; G06K 19/0708; G06K 19/07711; G06K 19/0723; G06K 19/07713; G06K 19/0712

(57) ABSTRACT

Systems and methods for operating an Electronic Smart Tag (“EST”). The methods comprise: harvesting, by an energy harvesting circuit of the EST, energy from an external energy source; using the energy to power at least a receiver and a display device of the EST; performing signal reception operations by the receiver to receive an original information bearing signal modulated in the external energy source; processing the original information bearing signal to obtain item related information therefrom; and causing the item related information to be displayed on the display device.

### BACKGROUND

### Statement of the Technical Field

The present disclosure concerns generally to labels and tags which display item related information (e.g., pricing information). More particularly, the present invention relates to implementing systems and methods for encoding display tags.

### Description of the Related Art

Many of merchandise in a department store have a printed tag attached to them that displays information about the product (such as the item's price and/or description). Furthermore, the same pricing tag may have an EAS component embedded therein or attached thereto for theft prevention. Once a pricing tag is affixed to a product, the information on the pricing tag cannot be easily modified.

In some scenarios, price labels are used to display the price for a group of merchandise. The price labels are often paper-based labels affixed to the shelves on which the merchandise is disposed. Paper-based labels require the tedious and manually-intensive process of printing and applying new labels every time there is a price or product description update. This is a laborious and time-consuming process for store associates.

### SUMMARY

The present invention concerns implementing systems and methods for operating an EST. The methods comprise: harvesting, by an energy harvesting circuit of the EST, energy from an external energy source (e.g., a magnetic field or RF signal); using the energy to power at least a receiver and a display device of the EST; performing signal reception operations by the receiver to receive an original information bearing signal modulated in the external energy source; processing the original information bearing signal to obtain item related information therefrom; and causing the item related information to be displayed on the display device. Notable, the supply of power to at least the display device is discontinued subsequent to when the item related information is displayed thereon.

In some scenarios, the original information bearing signal is modulated more than once in the external energy source. The original information bearing signal is modulated in the external energy source during the harvesting. The original information bearing signal comprises a first indicator indicating a start of the item related information and a second indicator indicating an end of the item related information.

In those or other scenarios, the energy harvesting circuit comprises (1) a coil that is excited via a magnetic coupling to the external energy source and (2) a capacitor that stores energy derived from the external energy source. The power is supplied to the receiver and a display device when the capacitor is partially or fully charged. Notably, the coil is part of the receiver and is used for magnetic induction communication of the original information bearing signal.

### BRIEF DESCRIPTION OF THE DRAWINGS

Embodiments will be described with reference to the following drawing figures, in which like numerals represent like items throughout the figures.

FIG. 1 is an illustration of an exemplary inventory system.

FIG. 2 is an illustration of an exemplary display for an Electronic Smart Tag (“EST”).

FIG. 3 provides an illustration of an exemplary architecture for the EST of FIG. 2.

FIG. 4 provides an illustration of an exemplary architecture for an EST.

FIG. 5 is an illustration of an exemplary energy source.

FIG. 6 is a flow diagram of an exemplary method for operating an EST.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

Dynamic displays are frequently used today in the marketplace. To support the integration of dynamic displays with security tags, a novel method is employed herein that (a) minimizes the extra weight of the security tags caused by incorporation of the dynamic displays therein and (b) does not require batteries to be provided for powering the electronic components of the security tags. Accordingly, the present solution concerns systems and methods for driving a dynamic display located in a security tag without a radio and/or battery. This is achieved by configuring the security tag to harvest energy from an external energy source (e.g., a magnetic field or RF signal). The harvested energy is then used to power the electronic components of the security tag. For example, the dynamic display is supplied power when information output therefrom needs to be updated. Notably, the dynamic display does not require any energy to be maintained. The only time power needs to be applied to the dynamic display is when the displayed information is to be changed (i.e., power is not required for the continued display of the updated information).

In some scenarios, this power is supplied by way of a coil located in the security tag. The coil is excited via its magnetic coupling to an external magnetic source (e.g., a handheld tag scanner) when the information displayed on the dynamic display is to be changed. As a result of the coil excitation, a storage device disposed in the security tag is charged. The storage device can include, but is not limited to, a capacitor. When the storage device is partially or fully charged, the new information is received at the security tag via a magnetic induction communication (e.g., by a series of magnetic pulses communicating the new information in an encoded format). The new information is then decoded in the security tag, and thereafter displayed on the dynamic display.

In other scenarios, this power is supplied by way of an antenna located in the security tag. The antenna is coupled to an RF energy harvester that collects energy from a received RF signal. The collected energy is stored in a storage device (e.g., a capacitor). When the storage device is partially or fully charged, the new information is received at the tag via an RF communication (e.g., by a modulated RF carrier wave communicating the new information in an encoded format). The new information is decoded in the tag, and thereafter displayed on the dynamic display.

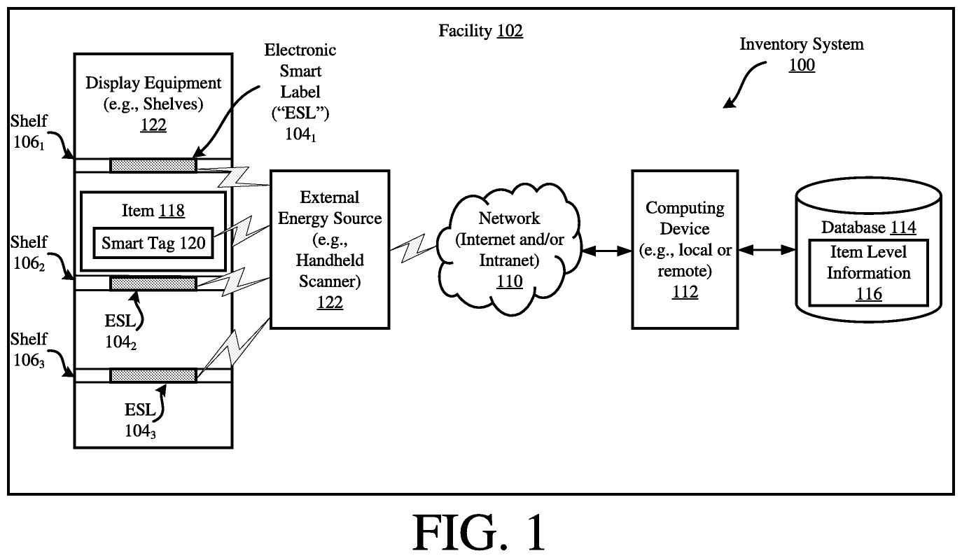

Referring now to FIG. 1, there is provided an illustration of an exemplary inventory system 100. Inventory system 100 is entirely or at least partially disposed within a facility 102. The facility 102 can include, but is not limited to, a manufacturer's facility, a distribution center facility, a retail store facility or other facility within a supply chain.

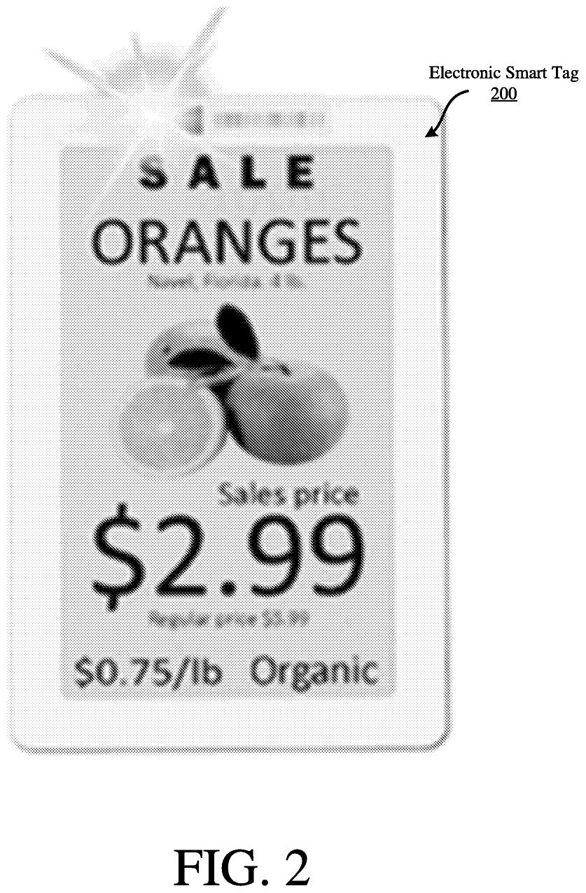

As shown in FIG. 1, at least one item 118 resides within the facility 102. The item 118 has an EST 120 coupled thereto. This coupling is achieved via an adhesive (e.g., glue), a mechanical coupler (e.g., straps, clamps, snaps, etc.), a weld, chemical bond or other means. The EST 120 is generally configured to provide a visual and/or auditory output of item level information. The item level information includes, but is not limited to, an item description, item nutritional information, a promotional message, an item regular price, an item sale price, a currency symbol, and/or a source of the item. The EST 120 will be described in detail below in relation to FIGS. 2-4. The item level information can be output in a format selected from a plurality of formats based on a geographic location of the item, a date, and/or an item pricing status (e.g., whether the item is on sale). In a display context, the format is defined by a font parameter, a color parameter, a brightness parameter, and/or a display blinking parameter. In an auditory context, the format is defined by a volume parameter, a voice tone parameter, and/or a male/female voice selection parameter.

The item 118 is disposed on display equipment 122. The display equipment includes, but is not limited to, shelves 106₁-106₃, display cabinets, and/or exhibit cases. In the shelf scenario, each shelf 106₁-106₃ may have an Electronic Smart Label (“ESL”) affixed thereto. ESLs are well known in the art, and therefore will not be described herein. Still, it should be understood that the ESLs display information relating to the items stored on the respective shelves.

The EST 120 and ESLs 104₁-104₃ comprise wireless communication components that enable the communication of item level information thereto and/or therefrom. The wireless communication components implement near field magnetic induction communication technology or RF communication technology. Near field magnetic induction communication technology and RF communication technology are well known in the art, and therefore will not be described herein. Any known or to be known near field magnetic induction communication technology and/or RF communication technology can be used herein without limitation.

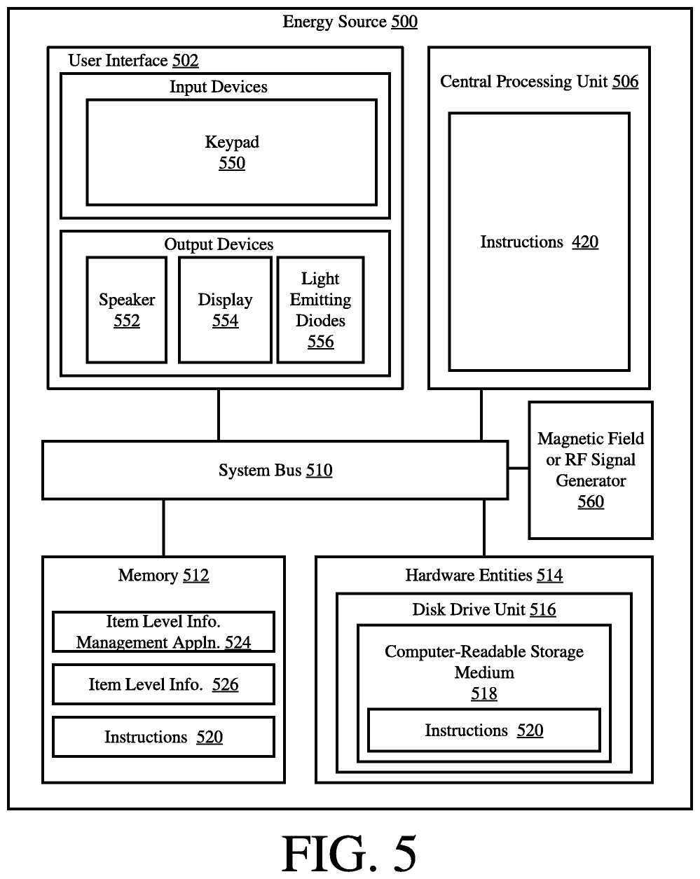

The item level information is provided to the EST and ESLs from a computing device 112 via a network 110 and an external energy source 122 (e.g., a handheld scanner). The computing device 112 can be local to the facility 102 as shown in FIG. 1 or remote from the facility 102. The computing device 112 will be described in detail below in relation to FIG. 5. However, at this time, it should be understood that the computing device 112 is configured to: write data to and read data from a database 114, EST 120 and/or ESLs 104₁-104₃; and/or perform language and currency conversion operations using item level information obtained from the database 114, EST 120 and/or ESLs 104₁-104₃. The data can include, but is not limited to, item level information 116.

Accordingly, the computing device 112 facilitates updates to the item level information output from the ESTs and ESLs. Such information updating can be performed periodically, in response to instructions received from an associate (e.g., a retail store employee), and/or in response to a detected change in the item level information 116. For example, if a certain product is placed on sale, then the sale price for that product is transmitted to the external energy source 122 via a long range communication (e.g., an RF communication), which in turn transmits the sale price to each EST/ESL associated with that product via a near field magnetic induction communication or RF communication. The sale price is then output from the ESTs/ESLs. The present solution is not limited to the particulars of this example.

The network 110 interconnects the computing device 112 with the external energy source 122. Network 110 can be a wired or wireless network facilitating communication between computing device 112 and the external energy source 122. The external energy source 122 receives the item level information 116 from the computing device 112, optionally translates and/or encodes this information, and sends it to the EST 120 and/or ESLs 104₁-104₃ via near field magnetic induction communication(s) or RF communication(s).

Although a single computing device 112 is shown in FIG. 1, the present solution is not limited in this regard. It is contemplated that more than one computing device can be implemented. Also, the present solution is not limited to the exemplary inventory system architecture described in relation to FIG. 1.

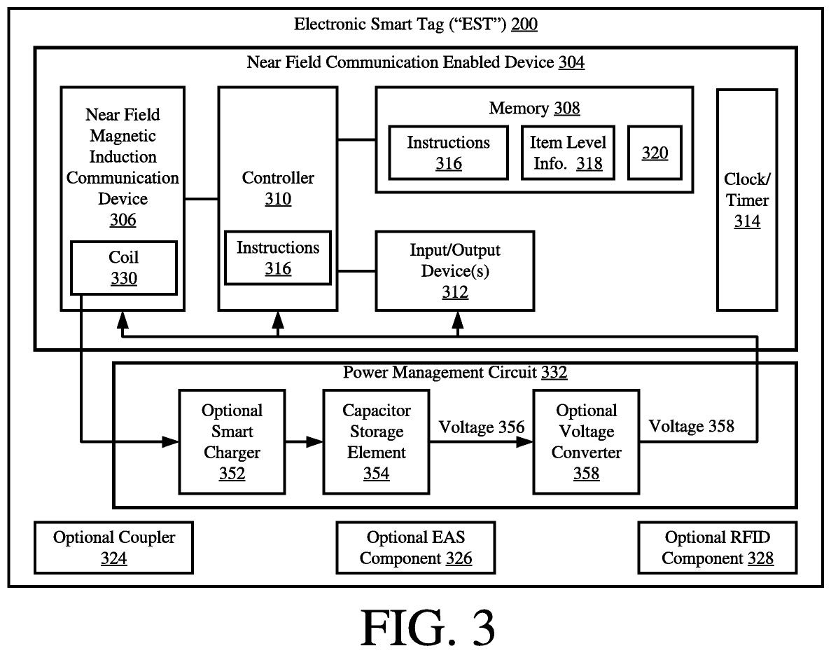

Referring now to FIG. 2, there is an illustration of an exemplary EST 200 displaying item level information. An exemplary architecture for the EST 200 is provided in FIG. 3. EST 120 and/or ESLs 104₁-104₃ of FIG. 1 is/are the same as or substantially similar to EST 200. As such, the discussion of EST 200 is sufficient for understanding the EST 120 and/or ESLs 104₁-104₃ of FIG. 1.

The EST 200 can include more or less components than that shown in FIG. 3. However, the components shown are sufficient to disclose an illustrative embodiment implementing the present solution. Some or all of the components of the EST 200 can be implemented in hardware, software and/or a combination of hardware and software. The hardware includes, but is not limited to, one or more electronic circuits. The electronic circuit(s) may comprise passive components (e.g., capacitors and resistors) and active components (e.g., processors) arranged and/or programmed to implement the methods disclosed herein.

The hardware architecture of FIG. 2 represents a representative EST 200 configured to facilitate improved inventory pricing management. In this regard, the EST 200 is configured for allowing data to be exchanged with an external device (e.g., external energy source 122 and/or computing device 112 of FIG. 1) via wireless communication technology. The wireless communication technology can include, but is not limited to, near field magnetic induction communication technology.

The components 306-314 shown in FIG. 3 may be collectively referred to herein as a near field communication enabled device 304, and include a memory 308 and a clock/timer 314. Memory 308 may be a volatile memory and/or a non-volatile memory. For example, the memory 308 can include, but is not limited to, Random Access Memory (“RAM”), Dynamic RAM (“DRAM”), Static RAM (“SRAM”), Read Only Memory (“ROM”) and flash memory. The memory 308 may also comprise unsecure memory and/or secure memory.

As shown in FIG. 3, the near field communication enabled device 304 comprises a Near Field Magnetic Induction Communication (“NFMIC”) device 306 for allowing data to be exchanged with an external device via a wireless communication technology. NFMICs are well known in the art, and therefore will not be described herein. Any known or to be known NFMIC can be used herein without limitation. In some cases, the NFMIC generates and magnetically transmits signals to external devices, as well as receives signals magnetically transmitted from external devices. In this way, the communication enabled device 304 facilitates the registration, identification, location and/or tracking of an item (e.g., item 118 of FIG. 1) to which the EST 200 is coupled. The communication enabled device 304 also facilitates the automatic and dynamic modification of item level information that is being or is to be output from the EST 200 in response to certain trigger events. The trigger events can include, but are not limited to, the EST's arrival at a particular facility (e.g., facility 102 of FIG. 1), the EST's arrival in a particular country or geographic region, a date occurrence, a time occurrence, a price change, and/or the reception of user instructions.

Item level information 318 and/or other information 320 associated with the identification and/or location of the EST 200 can be stored in memory 308 of the communication enabled device 304 and/or communicated to other external devices (e.g., computing device 112 of FIG. 1) via NFMIC device 306. For example, the communication enabled device 304 can communicate information specifying a timestamp, a unique identifier, item description, item price, a currency symbol and/or location information to an external computing device. The external computing device (e.g., an external energy source 122 of FIG. 1) can then store the information in a database (e.g., database 114 of FIG. 1) and/or use the information during language and/or currency conversion operations.

The communication enabled device 304 also comprises a controller 310 and input/output devices 312. The controller 310 can also execute instructions 316 implementing methods for facilitating the management of item pricing. In this regard, the controller 310 includes a processor (or logic circuitry that responds to instructions) and the memory 308 includes a computer-readable storage medium on which is stored one or more sets of instructions 316 (e.g., software code) configured to implement one or more of the methodologies, procedures, or functions described herein. The instructions 316 can also reside, completely or at least partially, within the controller 310 during execution thereof by the EST 200. The memory 308 and the controller 310 also can constitute machine-readable media. The term “machine-readable media”, as used here, refers to a single medium or multiple media (e.g., a centralized or distributed database, and/or associated caches and servers) that store the one or more sets of instructions 316. The term “machine-readable media”, as used here, also refers to any medium that is capable of storing, encoding or carrying a set of instructions 316 for execution by the EST 200 and that cause the EST 200 to perform any one or more of the methodologies of the present disclosure.

The input/output devices can include, but are not limited to, a display (e.g., an LCD display, a segmented display, and/or an active matrix display), a speaker, a keypad and/or light emitting diodes. The segmented display and/or active matrix display can include those available from E Ink Corporation of Cambridge, Mass. The display is used to present item level information in a textual format and/or graphical format. Similarly, the speaker may be used to output item level information in an auditory format. The speaker and/or light emitting diodes may be used to output alerts for drawing a person's attention to the EST 200 and/or for notifying the person of a particular pricing status (e.g., on sale status) of the item to which the EST is coupled.

The clock/timer 314 is configured to determine a date, a time, and/or an expiration of a pre-defined period of time. Technique for determining these listed items are well known in the art, and therefore will not be described herein. Any known or to be known technique for determining these listed items can be used herein without limitation.

The EST 200 also comprises an optional coupler 324 to securely or removably couple the EST 200 to an item (e.g., item 118 of FIG. 1). The coupler 324 includes, but is not limited to, a mechanical coupling means (e.g., a strap, clip, clamp, snap) and/or adhesive (e.g., glue or sticker). The coupler 324 is optional since the coupling can be achieved via a weld and/or chemical bond.

The EST 200 can also include an optional Electronic Article Surveillance (“EAS”) component 326 and/or an optional passive/active/semi-passive RFID component 328. Each of the listed optional components 326, 328 is well known in the art, and therefore will not be described herein. Any known or to be known EAS component and/or RFID component can be used herein without limitation.

The power management circuit 332 is generally configured to control the supply of power to the components of the EST 200. The power management circuit 334 is not limited to the particular architecture shown in FIG. 3. In this regard, it should be understood that the power management circuit 332 can include more or less components than that shown in FIG. 3.

As shown in FIG. 3, the power management circuit 332 comprises an optional smart charger 352, a capacitor storage element 354, and an optional DC-DC voltage converter 358 electrically connected to a load(s) 304. The smart charger 352 is generally configured to control and monitor the charging process of the capacitor storage element 354 (e.g., for purposes of ensuring efficient charging). The DC-DC voltage converter is generally configured to receive a voltage 356 output from the capacitor storage element 354 and change a level thereof so as generate voltage 358.

Notably, the coil 330 of the NFMIC device 306 is electronically connected to the power management circuit 332 so that the capacitor storage element 354 is charged in response to an excitation thereof via an external magnetic energy source (e.g., external energy source 122 of FIG. 1). When the capacitor storage element 354 is at least partially charged (i.e., to a level that is sufficient to at least power the communication device 304 of the EST 200), the power management circuit 332 supplies power to the NFMIC device 306.

In turn, the NFMIC device 306 performs signal reception operations. For example, the NFMIC device 306 receives a signal communicated from the external magnetic energy source via magnetic induction communication technology. This reception is achieved by measuring a modulated magnetic field to obtain the original information-bearing signal therefrom. The modulated magnetic field is the same magnetic field that was used to collect energy by the power management circuit 332. The signal comprises a series of magnetic pulses modulated in the magnetic field that communicates an original information bearing signal comprising new item related information in an encoded format. The series of magnetic pulses can be repeated any number of times within the signal. Notably, the signal includes a first start pulse or series of start pulses indicating the start of the encoded item related information, and a second end pulse or series of end pulses indicating the end of the encoded item related information.

Upon receipt of the signal, the NFMIC device 306 forwards the same to the controller 310. The signal is processed at the controller 310 to retrieve and decode the original information bearing signal communicating the new item related information. The new item related information is then stored in memory 308 and/or caused to be output from the EST 200. For example, the new item related information is displayed on the display 312 so as to replace old item related information. The present solution is not limited to the particulars of this example. In some scenarios, the new item related information is alternatively or additionally output from the EST via a speaker.

Data modulation and coding (i.e., encoding and decoding) techniques are well known in the art, and therefore will not be described herein. Any known or to be known data modulation and coding technique (that is suitable for use with magnetic induction communications) can be used herein without limitation.

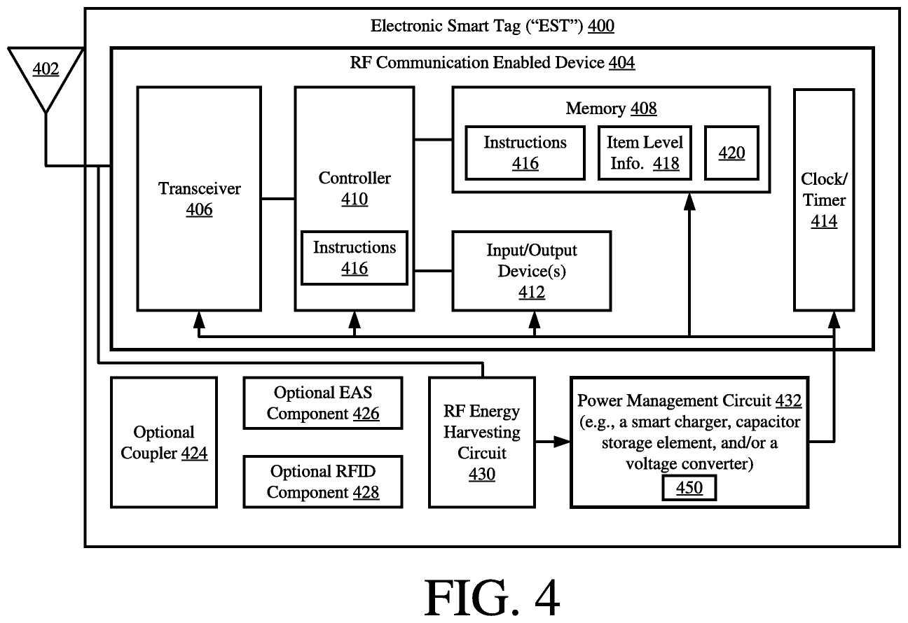

The present solution is not limited to the EST architecture shown in FIG. 3. Instead of employing magnetic induction to charge a capacitive storage element and/or communicate new item related information, Radio Frequency (“RF”) energy harvesting and communication are implemented in the EST. An exemplary architecture for the RF based implementation is provided in FIG. 4.

Referring now to FIG. 4, the EST 400 is generally configured to display item level information. EST 120 and/or ESLs 104₁-104₃ of FIG. 1 can be the same as or substantially similar to EST 400. The EST 400 can include more or less components than that shown in FIG. 4. However, the components shown are sufficient to disclose an illustrative embodiment implementing the present solution. Some or all of the components of the EST 400 can be implemented in hardware, software and/or a combination of hardware and software. The hardware includes, but is not limited to, one or more electronic circuits. The electronic circuit(s) may comprise passive components (e.g., capacitors and resistors) and active components (e.g., processors) arranged and/or programmed to implement the methods disclosed herein.

The hardware architecture of FIG. 4 represents a representative EST 400 configured to facilitate improved inventory pricing management. In this regard, the EST 400 is configured for allowing data to be exchanged with an external device (e.g., computing device 112 of FIG. 1) via wireless RF communication technology.

The components 406-414 shown in FIG. 4 may be collectively referred to herein as an RF communication enabled device 404, and include a memory 408 and a clock/timer 414. Memory 408 may be a volatile memory and/or a non-volatile memory. For example, the memory 408 can include, but is not limited to, Random Access Memory (“RAM”), Dynamic RAM (“DRAM”), Static RAM (“SRAM”), Read Only Memory (“ROM”) and flash memory. The memory 408 may also comprise unsecure memory and/or secure memory.

As shown in FIG. 4, the RF communication enabled device 404 comprises a transceiver 406 for allowing data to be exchanged with an external device via a wireless communication technology. Transceivers are well known in the art, and therefore will not be described herein. However, it should be understood that the transceiver generates and transmits signals to external devices, as well as receives signals transmitted from external devices. In this way, the communication enabled device 404 facilitates the registration, identification, location and/or tracking of an item (e.g., item 118 of FIG. 1) to which the EST 400 is coupled. The communication enabled device 404 also facilitates the automatic and dynamic modification of item level information that is being or is to be output from the EST 400 in response to certain trigger events. The trigger events can include, but are not limited to, the EST's arrival at a particular facility (e.g., facility 102 of FIG. 1), the EST's arrival in a particular country or geographic region, a date occurrence, a time occurrence, a price change, and/or the reception of user instructions.

Item level information 418 and/or other information 420 associated with the identification and/or location of the EST 400 can be stored in memory 408 of the communication enabled device 404 and/or communicated to other external devices (e.g., computing device 112 of FIG. 1) via RF communication enabled device 404. For example, the communication enabled device 404 can communicate information specifying a timestamp, a unique identifier, item description, item price, a currency symbol and/or location information to an external computing device. The external computing device (e.g., computing device 112 of FIG. 1) can then store the information in a database (e.g., database 114 of FIG. 1) and/or use the information during language and/or currency conversion operations.

The communication enabled device 404 also comprises a controller 410 and input/output devices 412. The controller 410 can also execute instructions 416 implementing methods for facilitating the management of item pricing. In this regard, the controller 410 includes a processor (or logic circuitry that responds to instructions) and the memory 408 includes a computer-readable storage medium on which is stored one or more sets of instructions 416 (e.g., software code) configured to implement one or more of the methodologies, procedures, or functions described herein. The instructions 416 can also reside, completely or at least partially, within the controller 410 during execution thereof by the EST 400. The memory 408 and the controller 410 also can constitute machine-readable media. The term “machine-readable media”, as used here, refers to a single medium or multiple media (e.g., a centralized or distributed database, and/or associated caches and servers) that store the one or more sets of instructions 416. The term “machine-readable media”, as used here, also refers to any medium that is capable of storing, encoding or carrying a set of instructions 416 for execution by the EST 400 and that cause the EST 400 to perform any one or more of the methodologies of the present disclosure.

The input/output devices can include, but are not limited to, a display (e.g., an LCD display, a segmented display, and/or an active matrix display), a speaker, a keypad and/or light emitting diodes. The segmented display and/or active matrix display can include those available from E Ink. The display is used to present item level information in a textual format and/or graphical format. Similarly, the speaker may be used to output item level information in an auditory format. The speaker and/or light emitting diodes may be used to output alerts for drawing a person's attention to the EST 400 and/or for notifying the person of a particular pricing status (e.g., on sale status) of the item to which the EST is coupled.

The clock/timer 414 is configured to determine a date, a time, and/or an expiration of a pre-defined period of time. Technique for determining these listed items are well known in the art, and therefore will not be described herein. Any known or to be known technique for determining these listed items can be used herein without limitation.

The EST 400 also comprises an optional coupler 424 to securely or removably couple the EST 400 to an item (e.g., item 118 of FIG. 1). The coupler 424 includes, but is not limited to, a mechanical coupling means (e.g., a strap, clip, clamp, snap) and/or adhesive (e.g., glue or sticker). The coupler 324 is optional since the coupling can be achieved via a weld and/or chemical bond.

The EST 400 can also include an optional EAS component 426 and/or an optional passive/active/semi-passive RFID component 428. Each of the listed optional components 426, 428 is well known in the art, and therefore will not be described herein. Any known or to be known EAS component and/or RFID component can be used herein without limitation.

The RF energy harvesting circuit 430 is generally configured to harvest energy from an external RF source. RF energy harvesters are well known in the art, and therefore will not be described herein in detail. Any known or to be known RF energy harvester can be used herein without limitation. Energy harvested by the RF energy harvesting circuit 430 is provided to the power management circuit 432.

The power management circuit 432 is generally configured to control the supply of power to the components of the EST 400. The power management circuit 432 can include, but is not limited to, a smart charger (not shown), a capacitive storage element 450 and/or a voltage converter (not shown). In some scenarios, the power management circuit 432 is the same as or substantially similar to power management circuit 332 of FIG. 3.

Notably, the antenna 402 is electronically connected to the RF energy harvesting circuit 430 so that energy is harvested from RF signals received at the EST 400. Harvested energy is then provided to the power management circuit 432 so that a capacitor storage element 450 is charged. When the capacitor storage element 450 is at least partially charged (i.e., to a level that is sufficient to at least power the communication device 404 of the EST 400), the power management circuit 432 supplies power to the RF communications enabled device 404.

In turn, the RF communications enabled device 404 performs signal reception operations. For example, the RF communications enabled device 404 receives a modulated carrier wave signal communicated from the external device (e.g., external energy source 110 and/or computing device 112) via RF communication technology. Notably, the modulated carrier wave signal is the same RF signal used by the power management circuit 432 collect and store energy. The modulated carrier wave signal comprises an original information bearing signal communicating new item related information in an encoded format. The original information bearing signal can be repeated any number of times within the modulated carrier wave signal. Notably, the original information bearing signal includes a first start bit or series of start bits indicating the start of the encoded item related information, and a second end bit or series of end bit indicating the end of the encoded item related information.

Upon receipt of the original information bearing signal, the RF communications enabled device 404 forwards the same to the controller 410. The original information bearing signal is processed at the controller 410 to retrieve and decode the new item related information. The new item related information is then stored in memory 408 and/or caused to be output from the EST 400. For example, the new item related information is displayed on the display 412 so as to replace old item related information. The present solution is not limited to the particulars of this example. In some scenarios, the new item related information is alternatively or additionally output from the EST via a speaker.

Data modulation and coding (i.e., encoding and decoding) techniques are well known in the art, and therefore will not be described herein. Any known or to be known data modulation and coding technique (that is suitable for use with RF communications) can be used herein without limitation.

Referring now to FIG. 5, there is provided a detailed block diagram of an exemplary architecture for an energy source 500. External energy source 122 of FIG. 1 and/or computing device 112 of FIG. 1 is(are) the same as or substantially similar to energy source 500. As such, the following discussion of energy source 500 is sufficient for understanding external energy source 122 and/or computing device 112.

Energy source 500 may include more or less components than those shown in FIG. 5. However, the components shown are sufficient to disclose an illustrative embodiment implementing the present solution. The hardware architecture of FIG. 5 represents one embodiment of a representative external energy source configured to facilitate improved inventory pricing management. As such, the energy source 500 of FIG. 5 implements at least a portion of a method for automatically and dynamically modifying item level information output from ESTs and/or ESLs in accordance with the present solution.

Some or all the components of the energy source 500 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 5, the energy source 500 comprises a user interface 502, a Central Processing Unit (“CPU”) 506, a system bus 510, a memory 512 connected to and accessible by other portions of energy source 500 through system bus 510, and hardware entities 514 connected to system bus 510. The user interface can include input devices (e.g., a keypad 550) and output devices (e.g., speaker 552, a display 554, and/or light emitting diodes 556), which facilitate user-software interactions for controlling operations of the energy source 500.

At least some of the hardware entities 514 perform actions involving access to and use of memory 512, which can be a RAM, a disk driver and/or a Compact Disc Read Only Memory (“CD-ROM”). Hardware entities 514 can include a disk drive unit 516 comprising a computer-readable storage medium 518 on which is stored one or more sets of instructions 520 (e.g., software code) configured to implement one or more of the methodologies, procedures, or functions described herein. The instructions 520 can also reside, completely or at least partially, within the memory 512 and/or within the CPU 506 during execution thereof by the energy source 500. The memory 512 and the CPU 506 also can constitute machine-readable media. The term “machine-readable media”, as used here, refers to a single medium or multiple media (e.g., a centralized or distributed database, and/or associated caches and servers) that store the one or more sets of instructions 520. The term “machine-readable media”, as used here, also refers to any medium that is capable of storing, encoding or carrying a set of instructions 320 for execution by the energy source 500 and that cause the energy source 500 to perform any one or more of the methodologies of the present disclosure.

In some scenarios, the hardware entities 514 include an electronic circuit (e.g., a processor) programmed for facilitating the provision of item level information in a language and currency used in a given geographic location whereat or wherein an EST or ESL resides. In this regard, it should be understood that the electronic circuit can access and run an item level information management application 524 installed on the energy source 500. The software application 524 is generally operative to: obtain item level information and/or other information from ESTs and/or ESLs; program item level information onto ESTs and/or ESLs; convert the language, pricing and/or currency symbol of item level information; and/or facilitate registration of ESTs and/or ESLs with inventory systems. Other functions of the software application 524 will become apparent as the discussion progresses.

The energy source 500 also comprises a Magnetic Field or RF Signal (“MFRFS”) generator 560. The MFRFS generator 590 is configured to generate a magnetic field and/or RF signal from which energy is to be captured and stored by an energy harvesting component provided with an EST (e.g., EST 120 of FIG. 1) and/or ESL (e.g., ESL 104₁, 104₂, 104₃ of FIG. 1). Notably, an original information bearing signal including item related information 526 can be encoded into the generated magnetic field and/or RF signal.

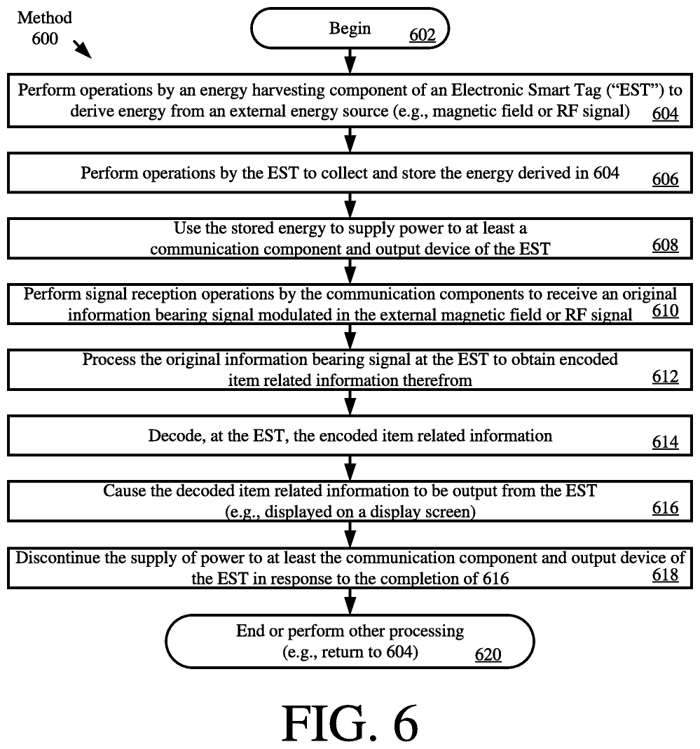

Referring now to FIG. 6, there is provided a flow diagram of an exemplary method 600 for operating an EST (e.g. EST 120 of FIG. 1 and/or EST 200 of FIGS. 2-4). Notably, method 600 can be implemented via an ESL instead of or in addition to an EST. A person skilled in the art would appreciate that certain modifications to method 600 would need to be made in this scenario.

As shown in FIG. 6, method 600 begins with 602 and continues with 604 where operations are performed by an energy harvesting component (e.g., coil 330 of FIG. 3 or RF energy harvesting circuit 430 of FIG. 4) of the EST to derive energy from an external energy source. In some scenarios, the external energy source comprises a magnetic field or RF signal. The derived energy is then collected and stored by the EST (e.g., by a power management circuit 332 of FIG. 3 or 432 of FIG. 4), as shown by 606. The stored energy is used in 608 to supply power to at least a communication component (e.g., NFMIC device 306 of FIG. 3 or transceiver 406 of FIG. 4) and output device (e.g., output device(s) 312 of FIG. 3 or 412 of FIG. 4) of the EST.

Next in 610, the communication component performs signal reception operations to receive an original information bearing signal modulated in the external magnetic field or RF signal. This processing can be achieved by (a) measuring a modulated magnetic field to obtain the original information-bearing signal or (b) demodulating a modulated carrier wave signal to obtain the original information-bearing signal. Notably, the modulated magnetic field and/or RF signal is the same as that used to collect and store energy at the EST. Various modulation and/or demodulation techniques are well known in the art, and therefore will not be described herein. Any known or to be known modulation/demodulation technique can be used herein without limitation.

As shown by 612, the original information bearing signal is processed at the EST to obtain encoded item related information therefrom. The encoded item related information is then decoded in 614. The decoding can be performed by a controller (e.g., controller 310 of FIG. 3 or 410 of FIG. 4) of the EST. Methods for encoding and decoding data are well known in the art, and therefore will not be described herein. Any known or to be known encoding/decoding method can be used herein without limitation.

Upon completing 614, 616 is performed where the decoded item related information is output from the EST. For example, the decoded item related information is used to update pricing information displayed on a display screen of the EST. The present solution is not limited to the particulars of this example. Once the information has been output from the EST, 816 is performed where the supply of power to the communication component and output device is discontinued. Subsequently, 620 is performed where method 600 ends or other processing is performed (e.g., method 600 returns to 604).

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A method for operating an Electronic Smart Tag (“EST”), comprising:
harvesting, by an energy harvesting circuit of the EST, energy from an external energy source;
using the energy to power at least a receiver and a display device of the EST;
performing signal reception operations by the receiver to receive an original information bearing signal modulated in the external energy source;
processing the original information bearing signal to obtain item related information therefrom; and
causing the item related information to be displayed on the display device.

2. The method according to claim 1, further comprising discontinuing the supply of power to at least the display device subsequent to when the item related information is displayed thereon.

3. The method according to claim 1, wherein the external energy source is a magnetic field.

4. The method according to claim 1, wherein the external energy source is an RF signal.

5. The method according to claim 1, wherein the original information bearing signal is modulated more than once in the external energy source.

6. The method according to claim 1, wherein the original information bearing signal is modulated in the external energy source during the harvesting.

7. The method according to claim 1, wherein the original information bearing signal comprises a first indicator indicating a start of the item related information and a second indicator indicating an end of the item related information.

8. The method according to claim 1, wherein the energy harvesting circuit comprises (1) a coil that is excited via a magnetic coupling to the external energy source and (2) a capacitor that stores energy derived from the external energy source.

9. The method according to claim 8, wherein power is supplied to the receiver and a display device when the capacitor is fully charged.

10. The method according to claim 8, wherein the coil is also part of the receiver and is used for magnetic induction communication of the original information bearing signal.

11. An Electronic Smart Tag (“EST”), comprising:
a display device;
a power source configured to harvest energy from an external energy source and use the energy to supply power to the display device;
a receiver configured to perform signal reception operations for receiving an original information bearing signal modulated in the external energy source, after power has been supplied thereto from the power source; and
a controller configured to process the original information bearing signal to obtain item related information therefrom and cause the item related information to be displayed on the display device.

12. The EST according to claim 11, wherein the supply of power to at least the receiver and display device is discontinued subsequent to when the item related information is displayed.

13. The EST according to claim 11, wherein the external energy source is a magnetic field.

14. The EST according to claim 11, wherein the external energy source is an RF signal.

15. The EST according to claim 11, wherein the original information bearing signal is modulated more than once in the external energy source.

16. The EST according to claim 11, wherein the original information bearing signal is modulated in the external energy source during the harvesting.

17. The EST according to claim 11, wherein the original information bearing signal comprises a first indicator indicating a start of the item related information and a second indicator indicating an end of the item related information.

18. The EST according to claim 11, wherein the power source comprises (1) a coil that is excited via a magnetic coupling to the external energy source and (2) a capacitor that stores energy derived from the external energy source.

19. The EST according to claim 18, wherein power is supplied to the receiver and a display device when the capacitor is fully charged.

20. The EST according to claim 18, wherein the coil is also part of the receiver and is used for magnetic induction communication of the original information bearing signal.
